(19) United States
(12) Patent Application Publication
(10) Pub. No.: US 2026/0267620 A1
(43) Pub. Date: Sep. 10, 2026

(54) AUTOMATIC LABELING OF MODEL-GENERATED SOURCE CODE

(71) Applicant: International Business Machines Corporation, Armonk, NY (US)

(72) Inventors: Dimitrij PANKRATZ, Boeblingen (DE); Timo KUSSMAUL, Boeblingen (DE); Oliver RAU, Pirmasens (DE); Ephraim PETRY, Stuttgart (DE); Falk POSCH, Holzgerlingen (DE); Marco PAVONE, Ehningen (DE); Muhammad Usman Karim KHAN, Sindelfingen (DE); Stefan LIESCHE, Boeblingen (DE)

(21) Appl. No.: 19/073,340

(22) Filed: Mar. 7, 2025

(51) Int. Cl. G06F 8/35; G06F 8/71; G06F 21/53

(52) U.S. Cl. CPC G06F 8/35; G06F 8/71; G06F 21/53; G06F 2221/033

(57) ABSTRACT

A computer-implemented method is described that includes receiving, within a trust boundary comprising one or more Trusted Execution Environments (TEEs), a prompt from a user requesting generation of source code, and transmitting, responsive to the prompt, a prompt request to a model stored within the trust boundary. The method further includes receiving a prompt result from the model, the prompt result including generated source code; updating, using the prompt request and the prompt result, a prompt history stored within the trust boundary; updating, responsive to an input indicating whether the user accepts the generated source code, a set of source code artifacts stored within the trust boundary; and updating a change history for the set of source code artifacts.

### BACKGROUND

The present disclosure relates to generating source code using models, and more specifically, to techniques for automatic and technically assured labeling of model-generated source code.

The ongoing development of various applications of artificial intelligence (AI) has given rise to significant challenges. For example, the creation of highly-realistic “deepfakes” and false news reporting has contributed to widespread disinformation and deception, as well as identity theft and other forms of fraud. In response, certain jurisdictions have enacted regulatory measures (e.g., the EU Artificial Intelligence Act) to require mandatory identification and labeling of artificially-generated content.

There are a number of different labeling techniques, but most are not well-suited to labeling model-generated source code. In one example, watermarking may be used to embed information within outputs such as audio, images, or text. However, watermarking may be limited and unreliable for source code due to the functionality and structure. In another example, tags, annotations, and/or comment may be added. However, these may be easily omitted or tampered with, such that technical assurance and verification may be inadequate to comply with regulatory requirements. In another example, tools may be used to detect artificially-generated content, but may be unreliable and/or unable to provide adequate context for the content (e.g., the prompts used to generate the content). In another example, version control systems and committer signatures may not provide adequate context, as the prompts are typically not included in the change history.

### SUMMARY

According to one embodiment, a computer-implemented method includes receiving, within a trust boundary comprising one or more Trusted Execution Environments (TEEs), a prompt from a user requesting generation of source code, and transmitting, responsive to the prompt, a prompt request to a model stored within the trust boundary. The method further includes receiving a prompt result from the model, the prompt result including generated source code; updating, using the prompt request and the prompt result, a prompt history stored within the trust boundary; updating, responsive to an input indicating whether the user accepts the generated source code, a set of source code artifacts stored within the trust boundary; and updating a change history for the set of source code artifacts.

According to another embodiment, a computer system includes a processor set, one or more computer-readable storage media, and program instructions stored on the one or more computer-readable storage media to cause the processor set to perform operations. The operations include receiving, within a trust boundary comprising one or more Trusted Execution Environments (TEEs), a prompt from a user requesting generation of source code, and transmitting, responsive to the prompt, a prompt request to a model stored within the trust boundary. The operations further include receiving a prompt result from the model, the prompt result including generated source code; updating, using the prompt request and the prompt result, a prompt history stored within the trust boundary; updating, responsive to an input indicating whether the user accepts the generated source code, a set of source code artifacts stored within the trust boundary; and updating a change history for the set of source code artifacts.

According to another embodiment, a computer program product includes one or more computer-readable storage media, and program instructions stored on the one or more computer-readable storage media to perform operations. The operations include receiving, within a trust boundary comprising one or more Trusted Execution Environments (TEEs), a prompt from a user requesting generation of source code, and transmitting, responsive to the prompt, a prompt request to a model stored within the trust boundary. The operations further include receiving a prompt result from the model, the prompt result including generated source code; updating, using the prompt request and the prompt result, a prompt history stored within the trust boundary; updating, responsive to an input indicating whether the user accepts the generated source code, a set of source code artifacts stored within the trust boundary; and updating a change history for the set of source code artifacts.

### BRIEF DESCRIPTION OF THE DRAWINGS

FIG. 1 is a block diagram of an example computer environment for use in conjunction with one or more disclosed embodiments for automatic labeling of model-generated source code, according to one or more embodiments.

FIG. 2 is a block diagram of an example system for automatic labeling of model-generated source code, according to one or more embodiments.

FIG. 3 is an example method of automatic labeling of model-generated source code, according to one or more embodiments.

FIG. 4A is an example sequence diagram for automatic labeling of model-generated source code where the model-generated source code is accepted, according to one or more embodiments.

FIG. 4B is an example sequence diagram for automatic labeling of model-generated source code where alternate source code is provided, according to one or more embodiments.

FIG. 5 is an example method of auditing model-generated source code artifacts, according to one or more embodiments.

FIG. 6 is an example sequence diagram of auditing model-generated source code artifacts, according to one or more embodiments.

### DETAILED DESCRIPTION

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as labeling code 126 that performs automatic labeling of model-generated source code, and auditing code 128 that performs auditing of model-generated source code artifacts. In addition to the labeling code 126 and the auditing code 128, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the labeling code 126 and the auditing code 128, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

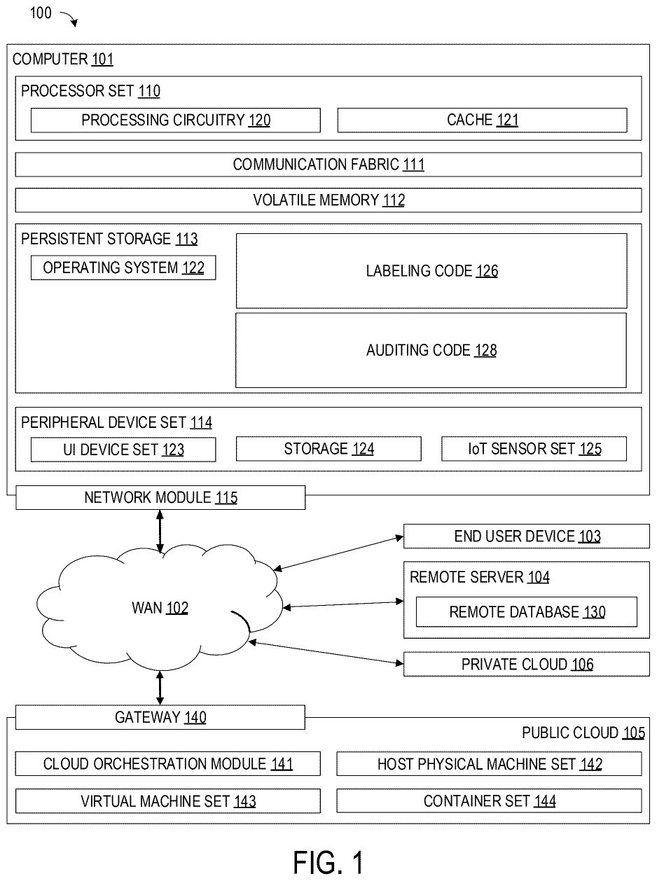

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the labeling code 126 and the auditing code 128 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the labeling code 126 and the auditing code 128 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

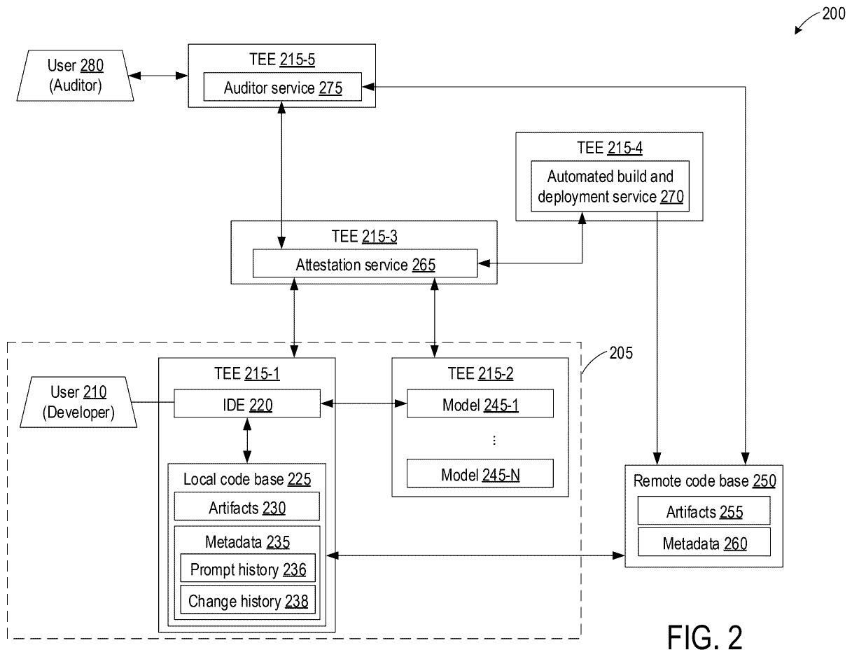

FIG. 2 is a block diagram of an example system 200 for automatic labeling of model-generated source code, according to one or more embodiments. The features of the system 200 may be used in conjunction with other embodiments, such as the labeling code 126 and the auditing code 128 implementing various functions described herein.

The system 200 comprises a plurality of Trusted Execution Environments (TEEs) 215-1, 215-2, . . . , 215-5 within which respective code executes to provide some or all of the functionality described herein. Each TEE 215-1, 215-2, . . . , 215-5 is a segregated area of processing and memory that is protected from the surrounding processing environment through encryption. In some embodiments, each TEE 215-1, 215-2, . . . , 215-5 comprises secure processing circuitry such as a secure portion of a main processor (or CPU) or processing circuitry that is segregated from the main processor. Similarly, each TEE 215-1, 215-2, . . . , 215-5 comprises a secure memory such as a segregated portion of a main volatile memory and/or main storage, or a volatile memory and/or storage that is separate from the main volatile memory and/or main storage. Each TEE 215-1, 215-2, . . . , 215-5 further comprises a trusted operating system (in some cases including supporting code) that executes using the secure processing circuitry and the secure memory, and code (e.g., as one or more trusted applications) that executes atop the trusted operating system to provide the respective functionality. In some embodiments, each TEE 215-1, 215-2, . . . , 215-5 provides secure start-up and runtime isolation that ensures the trustworthiness of the code execution.

An integrated development environment (IDE) 220 executes within a first TEE 215-1 for a user 210 (e.g., a developer) to develop software. In some embodiments, the IDE 220 implements the labeling code 126 of FIG. 1. The IDE 220 may be implemented to have any suitable functionality, such as a source code editor, a debugger, a compiler, an interpreter, and so forth.

In some embodiments, the IDE 220 provides a continuous tracking of changes during code development, and the IDE 220 submits the source code artifacts 230 and associated metadata 235 (including a change history 238) into a local code base 225 within the first TEE 215-1. The IDE 220 may further submit source code artifacts 255 and metadata 260 into a remote code base 250 external to the TEE 215-1. In some embodiments, the local code base 225 and/or the remote code base 250 are implemented as version control systems, and the metadata 235, 260 are cryptographically signed using any suitable techniques.

The IDE 220 communicates with one or more models 245-1, . . . , 245-N that provide AI code generation according to one or more prompts. In some embodiments, the prompts and the responses from the one or more models 245-1, . . . , 245-N are also stored as a prompt history 236 of the metadata 235. Each of the one or more models 245-1, . . . , 245-N may have any suitable implementation, such as a large language model (LLM) that has been trained on an existing body of source code, e.g., from publicly available open source projects. As shown, the one or more models 245-1, . . . , 245-N are stored in a second TEE 215-2 that is distinct from the first TEE 215-1; however, alternate implementations may have the one or more models 245-1, 245-N stored in the first TEE 215-1, may have the one or more models 245-1, . . . , 245-N stored in different TEEs, and so forth.

In some embodiments, a trust boundary 205 is defined to encompass the user 210 when authenticated, the first TEE 215-1 including the IDE 220 and the local code base 225, and the second TEE 215-2 including the one or more models 245-1, . . . , 245-N. In some embodiments, the user 210 is authenticated to the IDE 220 using an electronic device encompassed by the trust boundary 205, such as a smartphone or laptop computer that receives authentication information for the user 210 based on knowledge (e.g., a password or security question), ownership (e.g., a hardware-based or software-based token), and/or inherence (e.g., biometrics) of the user 210. The first TEE 215-1 is prevented from connecting to unauthorized models (e.g., models other than the one or more models 245-1, . . . , 245-N). In some embodiments, the trust boundary 205 may include other security measures, such as network protection, radio frequency jammers, video surveillance systems, and so forth.

In some embodiments, the IDE 220 presents a graphical user interface (GUI) to the user 210, and receives a prompt from the user 210 requesting generation of source code. In some cases, the prompt may reference a particular source code artifact 230 (e.g., the user 210 selects one or more lines of source code in the GUI to request replacement of, or edits to, the source code artifact 230). In some cases, the prompt may specify a requirement or a preference that the source code be generated by a particular model of the one or more models 245-1, . . . , 245-N. The IDE 220 may check the suitability of the specified model to generate the source code. For example, the IDE 220 may determine whether the referenced source code artifact 230 is confidential and therefore unable to be sent to the specified model.

The IDE 220 transmits a prompt request to a model within the trust boundary 205 (e.g., one of the one or more models 245-1, . . . , 245-N). In some embodiments, the prompt request comprises information from the prompt and may further comprise contextual information. The contextual information may include one or more references, e.g., a reference to a file within the local code base 225, a reference to a particular source code artifact 230, a reference to previous prompt request(s), and so forth. The contextual information may include environmental information, such as information about the IDE 220, the TEE 215-1, the user 210, and so forth.

The prompt request may have any suitable formatting, such as structured or semi-structured data of a prompt request object. Table 1 includes an example of a source code artifact 230, a portion of which is then referenced (e.g., “selection” with character index values) within an example of a prompt request object in Table 2.

TABLE 1

```
public class GreetingHelper {
  public static String greet( ) {
    return [symbol] World [symbol] ;
  }
} [symbol]
indicates data missing or illegible when filed
```

```
TABLE 2
prompt-request:
  id: 9159f9e49a7697d [symbol] da335222d791 [symbol] 19be183da870 [symbol] 08966178ba96f11 [symbol] e
  url: socket://var/run/awesome-ai/generate? [symbol] =param
  user-input: Change the greeting to say goodbye
  context:
```

| | |
|---|---|
| - | type: file |
| | path: [symbol] /GreetingHelper:java |
| | hash: 36 [symbol] 024f [symbol] a0c6abd45 [symbol] 61b9a7b7c [symbol] afca99d421bc [symbol] a3 [symbol] dc |
| - | type: selection |
| | start: 74 |
| | end: 95 |
| | file-path: [symbol] /GreetingHelper.java |

```
environment:
  development-environment:
    id: 3200f [symbol] 972459876a849e614a2d9d471537 [symbol] 1e4d270 [symbol] 8cfc61f [symbol] 7ca1cae [symbol]
    vendor: IBM
    name: Awesome AI Powered Development Environment
    version: 1.2.3
  ai-plugin:
    id:
    vendor: IBM
    name: Awesome AI Plugin
    version: 1.0.1
  ai-client:
    id: [symbol] b2ce4e33162e2194982a21b1e47a0a30c04c2ed1efed0d [symbol] 61005338fa4 [symbol] df2
    vendor: IBM
    name: Awesome AI Client Library
    version: 4.5.6
developer:
    id: 590 [symbol] dda [symbol] 7275ad970 [symbol] bd12b258e4f2cc1c [symbol] 6046f040542e74 [symbol] cc91c [symbol] a [symbol]
    user-id: user@domain.com
    name: Domain User [symbol]
indicates data missing or illegible when filed
```

The IDE 220 receives a prompt result from the model including the generated source code, which may comprise source code artifacts and/or code fragments. The prompt result may further include a reference to the prompt request, and environmental information, such as information about the model, the TEE 215-2, the user 210, and so forth. In some embodiments, the IDE 220 cryptographically signs the prompt request and the prompt result, and adds them into the prompt history 236 of the local code base 225.

The prompt result may have any suitable formatting, such as structured or semi-structured data of a prompt result object. Table 3 includes an example of a prompt result object.

```
TABLE 3
prompt-result:
  id: f72922 [symbol] fafe2d8e3b42d9b960ee39c0a8aa1a6626b1f5fe [symbol] 7e4 [symbol] a49e161
  request-id: 9159f9e49a7697d9f3da335222d791619be183da [symbol] 703680 [symbol] 66173ba [symbol] 6f113 [symbol] e
  request-url: socket://var/run/awesome-ai/generate [symbol] =param
  response: |
    I most certainly can do that. Here is your goodbye message

[symbol]

    return “Goodbye World!”;

[symbol]

environment [symbol]
  ai-model:
    id: 9abdf641c7248e774712 [symbol] b90491df31de [symbol] 52a36b46a03588543b6a84bf
    name: Granite-20B-Instruct-v1
    version: 3.0.1 (20240410)
  ai-server:
    id: [symbol] a2b23a2cec66988e [symbol] a4236880b3fd [symbol] 457 [symbol] bc0b [symbol] 0ae [symbol] 443 [symbol] d1 [symbol] da2c [symbol]
    name: Awesome AI Service
    version: 2.17.3
  ai-plugin:
    id: [symbol] 810bf8e409c [symbol] 2097e6 [symbol] a [symbol] ce6ee109b60cb [symbol] 664af84cf7d753c6c70347
    vendor: IBM
    name: Awesome AI Plugin
    version: 1.0.1
  ai-client:
    id: eb2ce4e33162e2194982a21b1e47a0a30c04c2ed1efed0d [symbol] 61005336fa435df2
    vendor: IBM
    name: Awesome AI Client Library
    version: 4.5.6
  development-environment:
    id: 3200f57c4b97245 [symbol] 6a849e614a2d9d47153755 [symbol] d270a8cfc61fb7ca [symbol] cae8
    vendor: IBM
    name: Awesome AI Powered Development Environment
    version: 1.2.3
developer:
  id: 590 [symbol] dda [symbol] e727 [symbol] ad [symbol] bd32b258e4f2cc1c [symbol] 46f0405 [symbol] e74 [symbol] cc [symbol] c [symbol] 5a94
  user-id: user@domain.com
  name: Domain User [symbol]
indicates data missing or illegible when filed
```

Thus, the prompt history 236 comprises a number of records (or entries) that describe each prompt, the context of the prompt, the response, and so forth. In some embodiments, each record includes some or all of the following fields: an identifier for the prompt, the content of the prompt, the context of the prompt (e.g., an identifier for the user 210, an identifier and version of the IDE 220, an identifier and version of the specified model), a list of source code artifacts 230 (or their parts) sent with the prompt request, an identifier of the prompt result, the content of the prompt result, an identifier and version of the model used, and a list of source code artifacts 230 (or their parts) returned with the prompt result.

The IDE 220 displays the prompt result to the user 210 (e.g., the text of the “response” field) through the GUI. In some cases, the user 210 accepts the generated source code of the prompt result, and the generated source code is added to the local code base 225 at a location that is based on its context or a location specified by the user 210. The IDE 220 then updates the source code artifacts 230 and the change history 238 according to the generated source code. The remote code base 250 may be updated with any suitable frequency to incorporate any changes made to the local code base 225, which can depend on the workflow and/or preferences of the developer (e.g., the user 210). In some embodiments, the developer (e.g., the user 210) causes the remote code base 250 to be updated to prior to operating the automated build and deployment service 270.

In some embodiments, the IDE 220 writes a file change to the change history 238 responsive to the accepted generated source code. In some embodiments, the file change includes information describing the change made to the source code, a reference to the file, a reference to the prompt request, a reference to the prompt result, a hash value for the file before the change, a hash value for the file after the change, environmental information, and so forth.

The file change may have any suitable formatting, such as structured or semi-structured data of a file change object. Table 4 includes an example of a file change object.

```
TABLE 4
file-change:
  id: 7ab3 [symbol] a [symbol] e2 [symbol] 72d24f6d7c55af9 [symbol] 330f038dfd8cf02334ecde0b625c288a
  path: [symbol] /GreetingHelper.java
  hash-before: a2777df706d8db [symbol] f63c12ace09318c70ccb4b293413ac27d36eb7c8f393938e
  hash-after: ffbe097369 [symbol] a4008e [symbol] a [symbol] 24e6f4cab8194 [symbol] 124127f [symbol] b99962 [symbol] f1 [symbol] 30b
  change-type: prompt-result-change
  change-metadata:
    request-id: 91 [symbol] 9f9e49a7697d9f3da33 [symbol] d79161 [symbol] 183d [symbol] 036 [symbol] 08966173ba96f11 [symbol] 5e
    result-id: f72922e [symbol] 1acfafe2d8e [symbol] b42d9b960 [symbol] e [symbol] c0a8aa1a6626b1f [symbol] fed7e49a49e161
  change: |
    −−− [symbol] /GreetingHelper.java 2024-04-12 12:00:24
    +++ [symbol] /GreetingHelper.java 2024-04-12 12:14:24 [symbol]
    −1,5 +1,5 [symbol]
      public class GreetingHelper {
        public static String greet( ) {
    − return “Hello World!”;
    + return “Goodbye World!”;
        }
      }
environment:
  development-environment [symbol]
    id: 3200f57c4b [symbol] 459876a849e614a2d [symbol] d471537551e4d270a [symbol] cfc61fb7ca1cae8
    vendor: IBM
    name: Awesome AI Powered Development Environment
    version: 1.2.3
  ai-plugin:
    id:
    vendor: IBM
    name: Awesome AI Plugin
    version: 1.0.1
developer:
  id: 590313dda8e727 [symbol] ad9703bd32b258e4f2cc1c86046f040542e7469cc91c55a94
  user-id: user@domain.com
  name: Domain User [symbol]
indicates data missing or illegible when filed
```

In other cases, the user 210 may not accept the generated source code of the prompt result as-is, but may modify the generated source code or may input different source code entirely. Table 5 includes an example of a file change object, in which the user 210 removed the generated source code (e.g., “Goodbye World!”) and provided alternate source code (e.g., “Goodbye Demo!”).

```
TABLE 5
file-change:
  id: 4376f1 [symbol] 1ac8d5ee5e9 [symbol] a945edbdfceb2b284d25f79192e37cd372 [symbol] 6 [symbol] d111c [symbol]
  path: [symbol] /GreetingHelper.java
  hash-before: ffbe0 [symbol] 73691717689a4003e4a [symbol] a6f4cab [symbol] 194553124127f [symbol] b939528f1 [symbol] 0b
  hash-after: a34e70d2c4f666129fc8631d1f645309f1a4b8cfbad09cb043540a57ddd1 [symbol] 258
  change-type: developer-change
  change: |
    −−− [symbol] /GreetingHelper.java 2024-04-12 12:14:24
    +++ [symbol] /GreetingHelper.java 2024-04-12 12:14:25 [symbol]
    −1,5 +1,5 [symbol]
      public class GreetingHelper (
        public static String greet( ) {
    − return “Goodbye World!”;
    + return “Goodbye Demo!”;
        }
      }
environment:
  development-environment:
    id: 3200f [symbol] 7c4b372459876a849e614a2d9d471 [symbol] 37551e4d270a8cfc61fb7ca1cae8
    vendor: IBM
    name: Awesome AI Powered Development Environment
    version: 1.2.3
developer:
  id: 590313dda8e7275ad [symbol] bd32b2 [symbol] e4f2cc1c86046f040542e74 [symbol] cc91c [symbol] a94
  user-id: user@domain.com
  name: Domain User [symbol]
indicates data missing or illegible when filed
```

Thus, the change history 238 comprises a number of records (or entries) that describe each change to the source code that has been tracked by the IDE 220, such as an identifier of the change, a type of the change (e.g., made by a prompt result, the IDE 220, the user 210) and an identifier of the changing entity, and so forth.

Using the techniques discussed above, each prompt, result, and change made to source code artifacts 230 can be continuously tracked by the IDE 220 and recorded into the cryptographically-signed metadata 235 within the TEE 215-1. This provides an attestable, pervasive history of source code generation, enabling attestation for character-level distinction between model-generated and developer-generated source code within the source code artifacts 230, a complete chain of traceability including the source code artifact, the model and version, the prompt, the IDE and developer, and authenticity of the evidence, TEEs, and developers included in generation of the source code artifacts.

An attestation service 265 operates within a third TEE 215-3 and attests to whether the relevant source code artifacts 230 are authentic. In some embodiments, the attestation service 265 may receive an attestation request that references a particular source code artifact 230 and the relevant metadata 235. Using the metadata 235, the attestation service 265 determines whether the source code artifact 230 has not been tampered with, has not expired, has not been revoked, originates from the correct TEE and is authentic, and so forth. The attestation service 265 may further communicate with the TEE 215-1 and/or the TEE 215-2 to make the determination.

In some embodiments, the IDE 220 may operate to detect any problems in the source code artifacts 230 and/or the metadata 235. In one example, the IDE 220 may strictly prevent calls to unpermitted models of the one or more models 245-1, . . . , 245-N, or based on policies of a specific project (e.g., permitting a specific model for one project, but disallowing the model for another project). In another example, the IDE 220 may prevent an update from the local code base 225 from being pushed to the remote code base 250 when a specific policy has been violated. The changes occurring within the local code base 225 tend to be more volatile, and in some cases can be canceled or abandoned without before being propagated to the remote code base 250. In some embodiments, the automated build and deployment service 270 and/or the auditor service 275 (discussed below) may operate to inspect the more stable remote code base 250.

The system 200 further supports an automated build and deployment of software applications. An automated build and deployment service 270 operates within a fourth TEE 215-4 and enables examination of the source code artifacts 255 and the metadata 260 of the remote code base 250 to determine whether the source code artifacts 255 comply with requirements to be built or deployed for the respective target. For example, the automated build and deployment service 270 may determine whether the source code artifacts 255 were generated only using approved one(s) of the one or more models 245-1, . . . , 245-N, may determine whether the first TEE 215-1 has been manipulated, and so forth. In some embodiments, during operation the automated build and deployment service 270 transmits an attestation request to the attestation service 265, and receives an attestation result. The automated build and deployment service 270 may have further functionality such as compilation of source code including various ones of the source code artifacts 255, testing, packaging, deployment, and so forth.

In this way, the automated build and deployment service 270 can operate as a central quality gate for detecting potential issues arising in the remote code base 250. In some embodiments, detecting the potential issues may occur while the remote code base 250 is being updated to match the local code base 225, or after the update has occurred.

The system 200 further supports auditing of the source code artifacts 255 within the remote code base 250. An auditor service 275 operates within a fifth TEE 215-5 and enables a user 280 (e.g., an auditor) to determine whether the source code artifacts 255 comply with one or more policies. In some embodiments, the auditor service 275 implements the auditing code 128 of FIG. 1. In some embodiments, the auditor service 275 provides an additional layer of security and compliance, performing intermittent investigations such as historical audits and/or spot-check inspections, while the automated build and deployment service 270 is used to provide substantially continuous or real-time inspections. In some embodiments, the auditor service 275 may be used to perform specific third-party certifications. Further, any issues with the automated build and deployment service 270 (such as compromise or malfunction) may be investigated by the auditor service 275 to detect these issues or otherwise provide evidence that everything operated correctly.

The auditor service 275 examines the source code artifacts 255 and the metadata 260 of the remote code base 250 to determine which of the source code artifacts 255 were model-generated (or include portions that are model-generated), which of the one or more models 245-1, . . . , 245-N were used, which user 210 submitted which prompt(s), and so forth.

In some embodiments, the auditor service 275 lists all of the source code artifacts 255 that were model-generated, as well as the particular model (in some cases, one of the one or more models 245-1, . . . , 245-N), version, an identity of the user, the prompt(s) used, and so forth. In this way, the auditor service 275 is able to determine whether only an approved IDE and model(s) (including an approved version) were used to generate the source code artifacts 255, that only approved and certified users created prompts that did not include restricted input, such as code artifacts that are restricted from being submitted to a third-party model, and so forth.

In some embodiments, during operation the auditor service 275 transmits an attestation request to the attestation service 265, e.g., to attest that the source code artifacts 255 were in fact generated using the specific model(s), version(s), developer(s), prompt(s), and so forth. The auditor service 275 receives an attestation result, which may be presented to the user 280 through a GUI.

In some embodiments, the auditor service 275 (or the IDE 220) determines that at least one source code artifact 255 of the set was generated by an unapproved model. The IDE 220 may be able to detect and prevent the initial transmission of a prompt to an unapproved model, as it would be external to the trust boundary 205. In some embodiments, the IDE 220 may deem a previously-approved model to be unapproved responsive to detecting a vulnerability or manipulation (e.g., a tampered signature in the prompt result).

The auditor service 275 (or the IDE 220) transmits, to an approved model, at least a portion of the prompt history (e.g., from the metadata 235 or the metadata 260) that was used to generate the at least one source code artifact. In this way, the auditor service 275 (or the IDE 220) is able to generate replacement source code to prevent use of the at least one source code artifact 255.

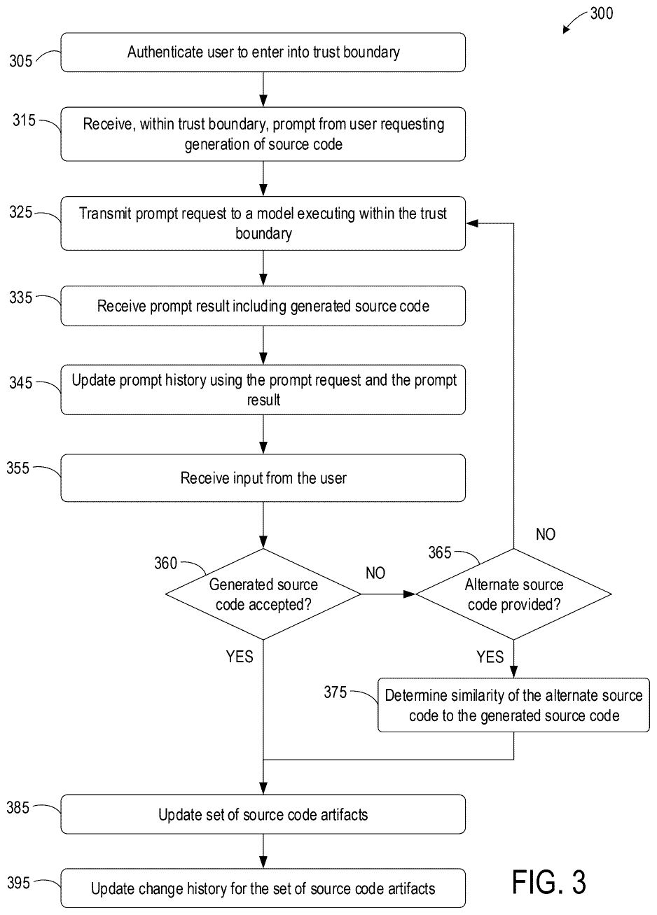

FIG. 3 is an example method 300 of automatic labeling of model-generated source code, according to one or more embodiments. The features described with respect to the method 300 may be used in conjunction with other embodiments. For example, the method 300 may be performed using the IDE 220 of FIG. 2.

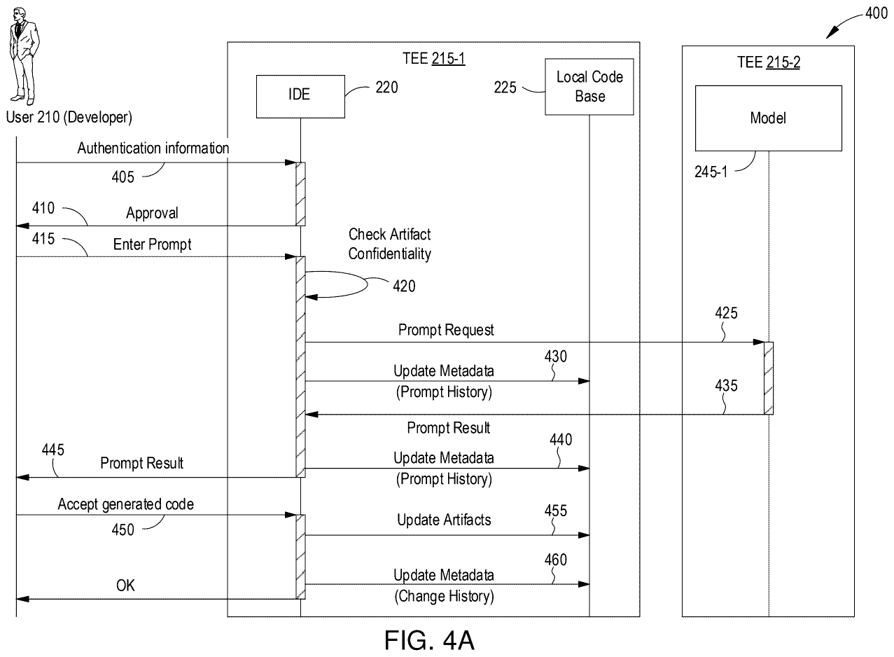

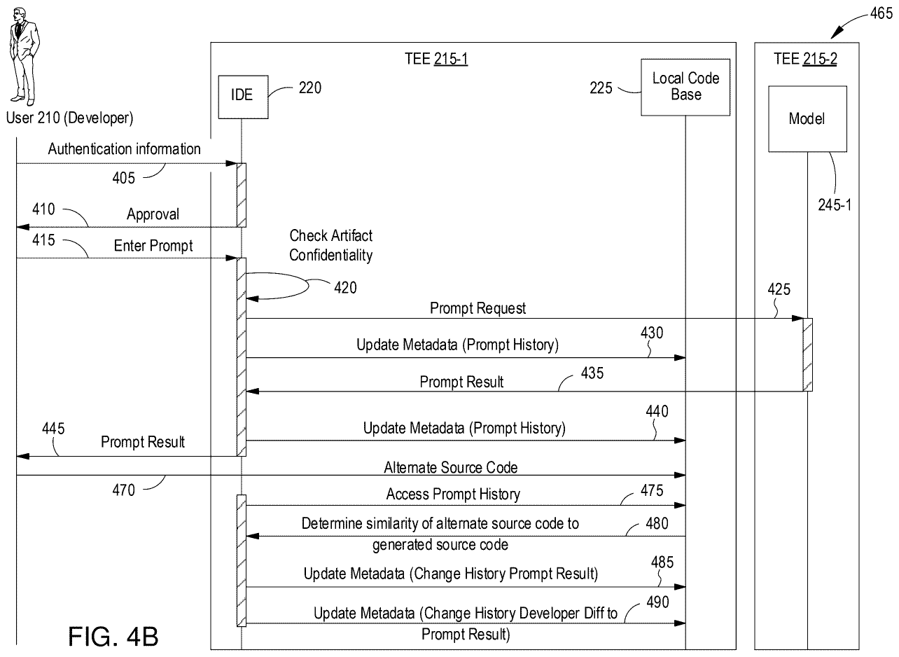

Referring also to the sequence diagram 400 of FIG. 4A, the method 300 begins at block 305, where the IDE 220 authenticates the user 210 to enter into the trust boundary 205. The trust boundary comprises one or more TEEs 215-1, . . . , 215-5, and the IDE 220 operates within a first TEE 215-1. In some embodiments, the IDE 220 receives authentication information 405 that had been provided to an electronic device associated with the user 210. The authentication information 405 may include knowledge information (e.g., a password or security question), ownership information (e.g., a hardware-based or software-based token), and/or inherence information (e.g., biometrics) of the user 210. The IDE 220 returns an approval 410 to the user 210 responsive to the authentication.

At block 315, the IDE 220 receives a prompt 415 from the user 210 requesting generation of source code. The prompt may be provided as unstructured text, e.g., a sentence typed by the user 210 into the associated electronic device. The prompt 415 may reference a particular source code artifact 230 and/or a particular model of one or more models 245-1, . . . , 245-M to be used. In some embodiments, the IDE 220 checks for confidentiality 420 of the source code artifact 230.

Responsive to determining that the source code artifact 230 is not restricted from being transmitted to the specified model (and in some cases, determining that the specified model is suitable to generate the source code), at block 325, the IDE 220 transmits a prompt request 425 to the model 245-1. In some embodiments, the prompt request 425 comprises information from the prompt 415 and may further comprise contextual information, such as one or more references and/or environmental information.

At block 335, the IDE 220 receives a prompt result 435 including the generated source code. The prompt result 435 may further include a reference to the prompt request 425 and/or environmental information.

At block 345, the IDE 220 updates the prompt history 236 using the prompt request 425 and the prompt result 435. The IDE 220 cryptographically signs the prompt request 425 and the prompt result 435, and adds them into the prompt history 236 of the local code base 225. In some embodiments, the IDE 220 updates the prompt history 236 in separate operations: a first operation 430 in which the prompt history 236 is updated responsive to transmitting the prompt request 425, and a second operation 440 in which the prompt history 236 is updated responsive to receiving the prompt result 435. In other embodiments, the IDE 220 may update the prompt history 236 in a single operation.

The IDE 220 presents the prompt result 445 to the user 210, and requests input to determine whether the user 210 accepts the generated source code. At block 355, the IDE 220 receives an input from the user 210. At block 360, the IDE 220 determines whether the input indicates that the generated source code is accepted. In FIG. 4A, the IDE 220 receives an input 450 indicating that the user 210 accepts the generated source code. Flow proceeds from block 360 to block 385 (“YES”), where the IDE 220 updates a set of source code artifacts 230 stored within the trust boundary 205 (e.g., the IDE 220 transmits an update 455 with the generated source code to the local code base 225). At block 395, the IDE 220 updates the change history 238 for the set of source code artifacts 230 (e.g., the IDE 220 transmits an update 460 to the local code base 225).

In the sequence diagram 465 of FIG. 4B, the user 210 provides an input indicating that the user 210 does not accept the generated source code. Flow proceeds from block 360 to block 365 (“NO”), where the IDE 220 determines whether alternate source code is provided. Where no alternate source code is provided, flow proceeds from block 365 to block 325 (“NO”), and the IDE 220 transmits a next prompt request to a model. In some embodiments, the IDE 220 may transmit the same prompt 415 from the user 210 to a different model (or with different context information), or may alter the prompt 415 before sending to the same model or a different model.

In the sequence diagram 465, the user 210 provides alternate source code as an input 470, and flow proceeds from block 365 to block 375 (“YES”), where the IDE 220 performs an operation 475 to access the prompt history 236 from the local code base 225. At operation 480 the IDE 220 determines, based on the prompt history, a similarity of the alternate source code to the model-generated source code. The IDE 220 may determine the similarity using any suitable techniques, such as a character-wise comparison between the alternate source code and the model-generated source code, calculating a “distance” between the model-generated source code and the alternate source code, a comparison of the respective overall functionality of the alternate source code and the model-generated source code, a comparison of the respective functionality of the difference between the alternate source code and the model-generated source code, and so forth.

The similarity may be represented in any suitable form, such as a binary decision (e.g., “similar” or “not similar”), a level, a numerical score, and so forth. In some embodiments, the similarity may be compared with a threshold value when making the determination. When the alternate source code is suitably similar to the model-generated source code (e.g., identical or exceeding the threshold value), the IDE 220 automatically attributes the alternate source code (or the similar portions thereof) as being model-generated. This prevents the inadvertent or deliberate misattribution of source code artifacts 230 as being authored by the user 210, and can provide technical assurance of regulatory compliance. The IDE 220 may further warn the user 210 or others of the similarity.

Flow proceeds to block 385, where the IDE 220 updates the set of source code artifacts 230. At block 395, the IDE 220 updates the change history 238 for the set of source code artifacts 230. In some embodiments, updating the change history 238 comprises an operation 485, where the IDE 220 updates the change history 238 with the prompt result 445, and an operation 490, where the IDE 220 updates the change history 238 with the user 210 provided difference from the prompt result 445 (e.g., based on the alternate source code). Thus, the evidence compiled by the IDE 220 (e.g., the prompts and change history) is attestable and auditable, in conjunction with the use of the one or more TEEs and the cryptographically-signed metadata. The method 300 ends following completion of block 395.

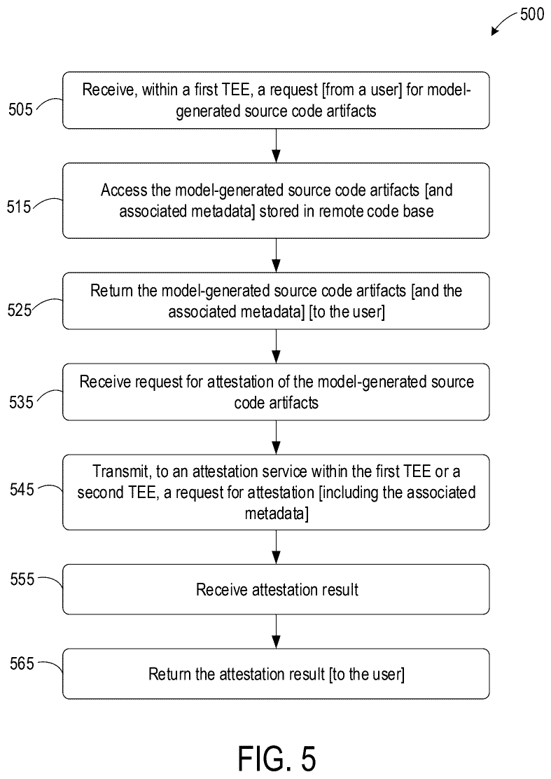

FIG. 5 is an example method 500 of auditing model-generated source code artifacts, according to one or more embodiments. The features described with respect to the method 500 may be used in conjunction with other embodiments. For example, the method 500 may be performed using the auditor service 275 of FIG. 2 operating within the fifth TEE 215-5.

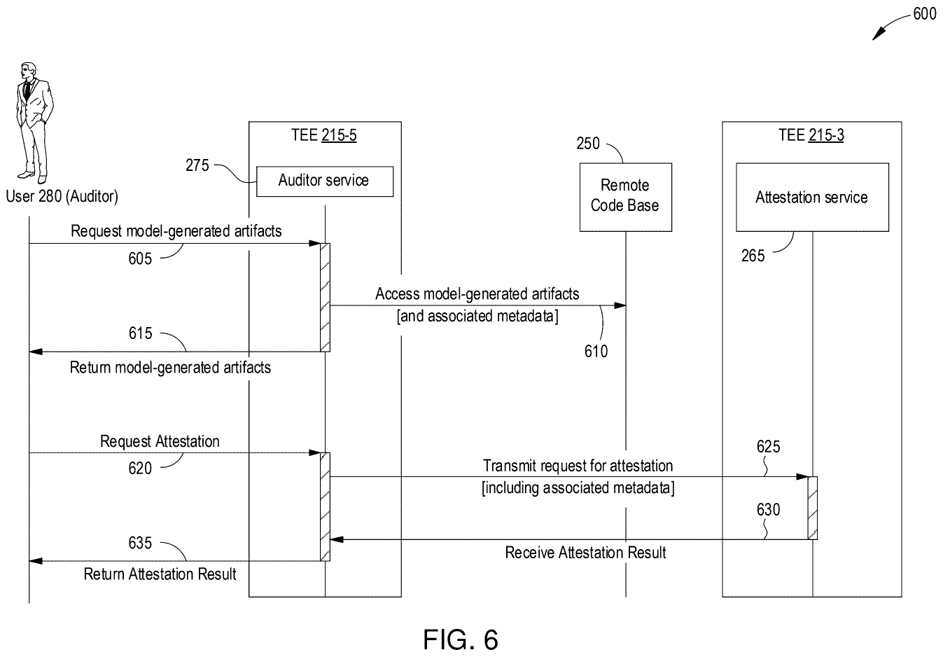

Referring also to the sequence diagram 600 of FIG. 6, the method 500 begins at block 505, where the auditor service 275 receives, within a first TEE (here, the fifth TEE 215-5), a request 605 for model-generated source code artifacts. In some embodiments, the request 605 is provided by the user 280 (e.g., an auditor).

At block 515, the auditor service 275 performs an operation 610 to access the model-generated source code artifacts 255 stored in the remote code base 250. In some embodiments, the auditor service 275 further accesses the metadata 260 associated with the model-generated source code artifacts 255. At block 525, the auditor service 275 performs an operation 615 to return the model-generated source code artifacts 255 (and in some cases, the metadata 260), which may be returned to the user 280.

At block 535, the auditor service 275 receives a request 620 (e.g., from the user 280) for attestation of the model-generated source code artifacts 255. At block 545, the auditor service 275 transmits, to the attestation service 265 within the fifth TEE 215-5 or a second TEE (here, the third TEE 215-3), a request 625 for attestation. The request may include the associated metadata 260. At block 555, the auditor service 275 receives the attestation result 630. At block 565, the auditor service 275 performs an operation 635 to return the attestation result 630 (e.g., to the user 280). The method 500 ends following completion of block 565.

While the foregoing is directed to embodiments of the present invention, other and further embodiments of the invention may be devised without departing from the basic scope thereof, and the scope thereof is determined by the claims that follow.

What is claimed is:

1. A computer-implemented method comprising:
receiving, within a trust boundary comprising one or more Trusted Execution Environments (TEEs), a prompt from a user requesting generation of source code;
transmitting, responsive to the prompt, a prompt request to a model stored within the trust boundary;
receiving a prompt result from the model, the prompt result including generated source code;
updating, using the prompt request and the prompt result, a prompt history stored within the trust boundary;
updating, responsive to an input indicating whether the user accepts the generated source code, a set of source code artifacts stored within the trust boundary; and
updating a change history for the set of source code artifacts.

2. The computer-implemented method of claim 1, wherein the prompt is received by a development environment executing within a first TEE of the one or more TEEs, and wherein the model is stored within the first TEE or within a second TEE of the one or more TEEs.

3. The computer-implemented method of claim 1, wherein the prompt history and the change history are stored within cryptographically-signed metadata of a first TEE of the one or more TEEs.

4. The computer-implemented method of claim 1, wherein the input indicates that the user accepts the generated source code, and wherein the updating the set of source code artifacts comprises adding the generated source code to one or more source code artifacts of the set.

5. The computer-implemented method of claim 1, wherein the input indicates that the user does not accept the generated source code, wherein the input comprises an alternate source code provided by the user, the method further comprising:
determining a similarity of the alternate source code to the generated source code; and
updating a change history stored within the trust boundary based on the determined similarity.

6. The computer-implemented method of claim 1, further comprising:
determining that at least one source code artifact of the set was generated by an unapproved model; and
transmitting, to an approved model, at least a portion of the prompt history that was used to generate the at least one source code artifact.

7. The computer-implemented method of claim 1, wherein the prompt request and the prompt result each include identification information, environment information, and user information.

8. A computer system comprising:
a processor set;
one or more computer-readable storage media; and
program instructions stored on the one or more computer-readable storage media to cause the processor set to perform operations comprising:
receiving, within a trust boundary comprising one or more Trusted Execution Environments (TEEs), a prompt from a user requesting generation of source code;
transmitting, responsive to the prompt, a prompt request to a model stored within the trust boundary;
receiving a prompt result from the model, the prompt result including generated source code;
updating, using the prompt request and the prompt result, a prompt history stored within the trust boundary;
updating, responsive to an input indicating whether the user accepts the generated source code, a set of source code artifacts stored within the trust boundary; and
updating a change history for the set of source code artifacts.

9. The computer system of claim 8, wherein the prompt is received by a development environment executing within a first TEE of the one or more TEEs, and wherein the model is stored within the first TEE or within a second TEE of the one or more TEEs.

10. The computer system of claim 8, wherein the prompt history and the change history are stored within cryptographically-signed metadata of a first TEE of the one or more TEEs.

11. The computer system of claim 8, wherein the input indicates that the user accepts the generated source code, and wherein the updating the set of source code artifacts comprises adding the generated source code to one or more source code artifacts of the set.

12. The computer system of claim 8, wherein the input indicates that the user does not accept the generated source code, wherein the input comprises an alternate source code provided by the user, the operations further comprising:
determining a similarity of the alternate source code to the generated source code; and
updating a change history stored within the trust boundary based on the determined similarity.

13. The computer system of claim 8, the operations further comprising:
determining that at least one source code artifact of the set was generated by an unapproved model; and
transmitting, to an approved model, at least a portion of the prompt history that was used to generate the at least one source code artifact.

14. The computer system of claim 8, wherein the prompt request and the prompt result each include identification information, environment information, and user information.

15. A computer program product comprising:
one or more computer-readable storage media; and
program instructions stored on the one or more computer-readable storage media to perform operations comprising:
receiving, within a trust boundary comprising one or more Trusted Execution Environments (TEEs), a prompt from a user requesting generation of source code;
transmitting, responsive to the prompt, a prompt request to a model stored within the trust boundary;
receiving a prompt result from the model, the prompt result including generated source code;
updating, using the prompt request and the prompt result, a prompt history stored within the trust boundary;
updating, responsive to an input indicating whether the user accepts the generated source code, a set of source code artifacts stored within the trust boundary; and
updating a change history for the set of source code artifacts.

16. The computer program product of claim 15, wherein the prompt is received by a development environment executing within a first TEE of the one or more TEEs, and wherein the model is stored within the first TEE or within a second TEE of the one or more TEEs.

17. The computer program product of claim 15, wherein the prompt history and the change history are stored within cryptographically-signed metadata of a first TEE of the one or more TEEs.

18. The computer program product of claim 15, wherein the input indicates that the user accepts the generated source code, and wherein the updating the set of source code artifacts comprises adding the generated source code to one or more source code artifacts of the set.

19. The computer program product of claim 15, wherein the input indicates that the user does not accept the generated source code, wherein the input comprises an alternate source code provided by the user, the operations further comprising:
determining a similarity of the alternate source code to the generated source code; and
updating a change history stored within the trust boundary based on the determined similarity.

20. The computer program product of claim 15, the operations further comprising:
determining that at least one source code artifact of the set was generated by an unapproved model; and
transmitting, to an approved model, at least a portion of the prompt history that was used to generate the at least one source code artifact.
